(19) United States
(12) Patent Application Publication
(10) Pub. No.: US 2008/0133103 A1
(43) Pub. Date: Jun. 5, 2008

(54) Method For Deactivating An Automatic Starting Function Of A Distance-Related Speed Control System

(75) Inventors: Alexander MESKE, Muenchen (DE); Dietrich STURM, Muenchen (DE); Thomas BURTSCHE, Muenchen (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 12/029,844

(22) Filed: Feb. 12, 2008

Related U.S. Application Data
(63) Continuation of application No. PCT/EP2006/007770, filed on Aug. 5, 2006.

(30) Foreign Application Priority Data
Aug. 13, 2005 (DE) 10 2005 038 489.7

(51) Int. Cl. B60T 7/12

(52) U.S. Cl. 701/96

(57) ABSTRACT

A method is provided for deactivating an automatic starting function of a distance-related speed control system in a motor vehicle. The speed control system performs a distance-related control in relation to a detected target object, and the motor vehicle is also held at a standstill owing to the stationary target object. Upon detection of a moving object between the stationary target object and one's own motor vehicle, the automatic starting function of the distance-related speed control system is automatically deactivated.

### CROSS-REFERENCE TO RELATED APPLICATIONS

This application is a continuation of PCT International Application No. PCT/EP2006/007770, filed Aug. 5, 2006, which claims priority under 35 U.S.C. §119 German Application No. 10 2005 038 489.7 filed Aug. 13, 2005 the entire disclosures of which are expressly incorporated by reference herein.

### BACKGROUND AND SUMMARY OF THE INVENTION

The invention relates to a method for deactivating an automatic starting function of a distance-related speed control system in a motor vehicle, wherein the speed control system performs a distance-related control in relation to a detected target object, and wherein the motor vehicle is also held at a standstill owing to the stationary target object.

Today, it is possible to acquire vehicles, which have a distance-related speed control system with a distance sensing system, from a variety of manufacturers. Such a system, which is offered, for example, by BMW under the name “active cruise control” makes it possible to automatically move the vehicle at a desired speed or a correspondingly lower speed while simultaneously maintaining a desired distance from a vehicle traveling ahead (such a vehicle is called the target object). In principle, the customary speed control system, which maintains a certain specified speed, is expanded by an additional distance sensing function, so that it is also possible to use such an “active” speed control system in dense highway or rural traffic. This so-called “active speed control” maintains the specified desired speed, when one's own lane is unobstructed. If a distance sensing system, which is mounted on the vehicle, detects a target object, i.e., a (motor) vehicle traveling ahead in one's own lane, one's own speed is adapted to that of the motor vehicle (target object) traveling ahead in such a manner that a distance control, which is contained in the “active speed control” or rather in the corresponding speed control system, automatically maintains a separation distance from the motor vehicle traveling ahead that is correct for the given situation.

Such “active cruise control” systems can be used only in a speed range of approximately 30 to 180 km/h. In a speed range below 30 km/h, this system cannot be activated or will automatically turn itself off in accordance with a specific algorithm. Moreover, stationary target objects—from which it is also absolutely necessary to maintain a separation distance—cannot be used for the control or can be used only under certain conditions.

The ability to use a speed control system having a distance sensing system even in a speed range below 30 km/h, especially in congested traffic situations, implies that the sensor's visual range is expanded to include additional sensors. Furthermore, an algorithm has to be able to differentiate between relevant immobile and driving target objects. One possible characteristic of the system design could consist of the feature that a distinction is made between a conventional control range, where there is no reaction to immobile targets, and a stop-and-go range, where there is a reaction to immobile target objects. This so-called stop-and-go range can be limited in terms of speed towards the top end by a limit value, for example, in a magnitude of 30 km/h. Such an expanded distance-related speed control system is disclosed, for example, in German patent document DE 101 51 717 A1.

German patent document DE 199 58 520 A1 also discloses such a system. According to this system, after a vehicle comes to a standstill in the controlled mode, it is possible to automatically start or rather drive away up to a certain specified time limit after stopping. According to this system, starting can take place only after the driver's enabling input.

The invention improves the functionality of the prior art distance-related speed control system, which can also be operated in the so-called stop-and-go range, with respect to the automatic starting function.

According to the invention, a method is provided for deactivating an automatic starting function of a distance-related speed control system in a motor vehicle, wherein the speed control system performs a distance-related control in relation to a detected target object, and wherein the motor vehicle is also held at a standstill owing to the stationary target object. Upon detection of a moving object between the stationary target object and the motor vehicle, the automatic starting function is automatically deactivated. Advantageous further developments are described and claimed herein.

In principle, a stationary object can be a target object for the distance-related speed control system only if it has already been detected beforehand as a driving object. In the case of a distance-related speed control system that is already active, an a priori stationary object will not become a target object. However, if the distance-related speed control system is not activated until the motor vehicle, which is equipped with the speed control system, is at a standstill, an already stationary object can also become a target object if the stationary object is the object that is the most relevant for the distance-related speed control.

The method according to the invention assumes that after a vehicle has come to a standstill, it is possible, in principle, for the vehicle, which is maintained in a controlled mode, to start automatically—at least for a certain period of time. However, in contrast to the known prior art, this method offers the advantage that this automatic starting function is deactivated automatically in a potentially dangerous situation. If in the event that the target object, which had been immobile beforehand, were to start up again and if one's own motor vehicle were simply to be put into motion based on the automatic starting function, a collision could occur if the driver were inattentive and another object were located between the previously detected target object and one's own motor vehicle. Such objects could be, for example, pedestrians or bikers, who have moved between the target object and one's one vehicle during the standstill phase. The driver must be informed of the deactivation of the automatic starting function by optical, acoustical or haptic means.

If an object is detected between the stationary target object and the motor vehicle, the automatic starting function is deactivated, preferably only if the direction of motion of the detected object runs essentially orthogonal to the longitudinal axis of the vehicle. This feature can guarantee that the automatic starting function will not be deactivated as soon as, for example, a bicyclist rides past the two motor vehicles and perhaps moves just slightly into the region between the stationary target object and the vehicle, which is equipped with the distance-related speed control system.

In order to automatically deactivate the starting function, the entire distance-related speed control system can be advantageously deactivated. Therefore, the driver of the motor vehicle has to first re-activate the distance-related speed control system if he would like to continue to use the functionality of this system. Thus, it can be guaranteed that an automatic start is performed only if the driver has intentionally re-activated the distance-related speed control system.

In order to prevent the motor vehicle from rolling away unintentionally after the deactivation of the distance-related speed control system, an advantageous feature provides that upon deactivation of the distance-related speed control system, an automatically activated brake function continues to hold the motor vehicle in the stationary state. The automatically activated brake is not released until the driver actuates an operator control element, which is provided to this end, for example, the actuating of the brake pedal. This take-over request is communicated to the driver by optical, acoustical or haptic means.

Other objects, advantages and novel features of the present invention will become apparent from the following detailed description of the invention when considered in conjunction with the accompanying drawings.

### BRIEF DESCRIPTION OF THE DRAWINGS

FIG. 1 depicts a traffic situation at time t1 in order to illustrate the method of the present invention; and

FIG. 2 depicts a traffic situation at time t2 in order to illustrate the method of the present invention.

### DETAILED DESCRIPTION OF THE DRAWINGS

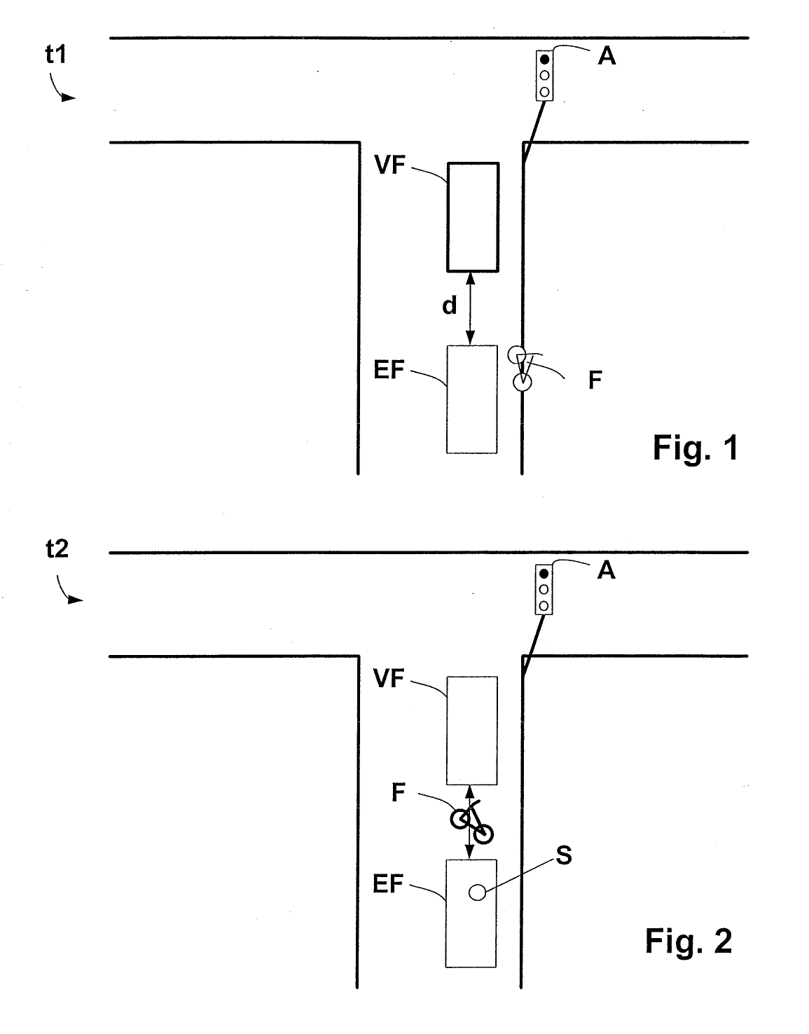

FIG. 1 depicts a traffic situation at a time t1 at a road crossing. One's own vehicle EF is equipped with a distance-related speed control system and is held stationary in a known manner as a function of the distance-related speed control at time t1 and at a distance d from the vehicle VF, which is traveling ahead or is stationary at the current time. The vehicle VF that is traveling ahead is the current target object VF. On the right, next to one's own vehicle EF, there is at time t1 another object, in particular a bicyclist F.

The distance-related speed control system of one's own vehicle EF includes an automatic starting function. Therefore, one's own vehicle EF would automatically startup and drive away, if the stationary target object were to move forward again.

FIG. 2 depicts a traffic situation, following the traffic situation from FIG. 1, at time t2. At this time t2, one's own vehicle EF is also held stationary on account of the stationary target object VF.

In contrast to the traffic situation in FIG. 1, at time t2 the bicyclist F is no longer next to one's own vehicle EF, but rather between the stationary target object VF and one's own vehicle EF. As soon as this moving object—that is, the bicyclist F—is detected between the two vehicles VF and EF, the distance-related speed control system with the integrated automatic starting function is automatically deactivated. In order to prevent one's own vehicle EF from unintentionally rolling away, an automatic brake function is activated simultaneously with the deactivation of the distance-related speed control system. Thus, one's own vehicle EF continues to be held stationary. In addition, the driver of the vehicle EF is informed by an acoustical signal S that the distance-related speed control system has been automatically deactivated and, thus, the driver has to again take over the control of his own vehicle EF.

As soon as the driver has performed the planned actuation of an operator control element for this situation that indicates that the driver of the vehicle EF has noticed the automatic deactivation of the distance-related speed control system, the automatic brake function is deactivated again. At this stage, the driver himself is responsible for braking his own vehicle EF.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method of operating an automatic starting function of a distance-related speed control system in a motor vehicle, the method comprising the acts of:
performing a distance-related control of the motor vehicle in relation to a detected target object;
holding the motor vehicle at a standstill due to a stationary target object; and
automatically deactivating the automatic starting function of the distance-related speed control system upon detecting a moving object between the stationary target object and the motor vehicle.

2. The method according to claim 1, wherein the act of automatically deactivating the automatic starting function occurs only if a direction of motion of the moving object extends essentially orthogonal to a longitudinal axis of the motor vehicle.

3. The method according to claim 1, wherein the act of automatically deactivating the automatic starting function is performed by deactivating the distance-related speed control system.

4. The method according to claim 2, wherein the act of automatically deactivating the automatic starting function is performed by deactivating the distance-related speed control system.

5. The method according to claim 3, further comprising the act of:
upon deactivation of the distance-related speed control system, maintaining the motor vehicle at a standstill.

6. The method according to claim 4, further comprising the act of:
upon deactivation of the distance-related speed control system, maintaining the motor vehicle at a standstill.

7. A distance-related speed control system for a motor vehicle, comprising:
means for controlling the motor vehicle in relation to a detected target object as a function of distance, said control means holding the motor vehicle at a standstill upon detecting a target object that is stationary;
means for automatically starting the motor vehicle that is held at a standstill; and
means for automatically deactivating the automatic starting means upon detecting a moving object between the target object that is stationary and the motor vehicle.

8. The system according to claim 7, wherein the means for automatically deactivating operates to deactivate the automatic starting means only if a direction of motion of the moving object extends essentially orthogonal to a longitudinal axis of the vehicle.

9. The system according to claim 8, wherein the means for automatically deactivating operates to deactivate the automatic starting means by deactivating the distance-related speed control system.

10. The system according to claim 9, further comprising means for holding the motor vehicle at a standstill upon deactivation of the distance related speed control system.

11. A method for deactivating an automatic starting function of a distance-related speed control system in a motor vehicle, the method comprising the acts of:
holding the motor vehicle at a standstill due to a stationary target object via the distance-related control system;
detecting a moving object between the stationary target object and the motor vehicle; and
automatically deactivating the automatic starting function of the distance-related speed control system upon detecting the moving object.
